(19) United States
(12) Patent Application Publication
(10) Pub. No.: US 2008/0043009 A1
(43) Pub. Date: Feb. 21, 2008

(54) DISPLAY APPARATUS AND METHOD OF DRIVING THE SAME

(76) Inventors: Bum-Joon KIM, Seoul (KR); Jong-Seok Chae, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/838,688

(22) Filed: Aug. 14, 2007

(30) Foreign Application Priority Data
Aug. 16, 2006 (KR) 2006-77093

(51) Int. Cl. G09G 5/00

(52) U.S. Cl. 345/211; 345/1.1

(57) ABSTRACT

A display apparatus includes first and second display panels, and first and second driver circuit parts. The first display panel includes first pixels. Each of the first pixels includes a switching element electrically connected to a gate line and a source line, and a first liquid crystal capacitor electrically connected to the switching element. The second display panel includes second pixels. Each of the second pixels includes a second liquid crystal capacitor formed by a scan electrode and a segment electrode. The segment electrode is extended along a direction crossing a longitudinal direction of the scan electrode. The first driver circuit part drives the first display panel by using first driving voltages. The second driver circuit part drives the second display panel by using second driving voltages generated by adjusting the first driving voltages.

### CROSS-REFERENCE TO RELATED APPLICATIONS

This application claims priority under 35 U.S.C. §119 to Korean Patent Application No. 2006-77093, filed on Aug. 16, 2006 in the Korean Intellectual Property Office (KIPO), the contents of which are herein incorporated by reference in their entirety.

### BACKGROUND OF THE INVENTION

1. Field of the Invention

The present invention relates to a display apparatus and a method of driving the display apparatus.

2. Description of the Related Art

The display panel of a cellular phone may be exposed or included with a keypad on panels connected to each other by a hinge. The folder-type cellular phone may have a main display panel displaying a main image and a sub-display panel displaying a standby image, such as a time, a date, a reception sensitivity level, etc. The main display panel may be located opposite the keypad so that the main display panel is not exposed while the sub-display panel is exposed so that a user may view the standby image without opening the cellular phone.

The main driver driving the main display panel and a sub-driver driving the sub-display panel are typically separated from each other which increases the number of elements for the main and sub-driver s and therefor the cost of manufacture as well as the size of the cell phone.

### SUMMARY OF THE INVENTION

The present invention provides a display apparatus capable of reducing the number of circuit elements, manufacturing costs, and overall size as well as a method of driving the display apparatus.

A display apparatus according to an example embodiment of the present invention includes a first display panel, a second display panel, a first driver circuit and a second driver circuit. The first display panel includes a plurality of first pixels. Each of the first pixels includes a switching element electrically connected to a gate line and a source line, and a first liquid crystal capacitor electrically connected to the switching element. The second display panel includes a plurality of second pixels. Each of the second pixels includes a second liquid crystal capacitor formed by a scan electrode and a segment electrode. The segment electrode is extended along a direction crossing a longitudinal direction of the scan electrode. The first driver circuit drives the first display panel by using first driving voltages. The second driver circuit drives the second display panel by using second driving voltages obtained by adjusting the first driving voltages.

A method of driving a display apparatus having first and a second display panels, the first panel having plurality of pixels, switching elements and liquid crystal capacitors electrically connected to the switching elements, the second panel having a second liquid crystal capacitor formed by a scan electrode and a segment electrode extended along a direction crossing a longitudinal direction of the scan electrode, the driving method comprising driving the first display panel with a first driving voltage and driving the second panel with a second driving voltage derived from the first driving voltage thereby reducing the number of required circuit elements. As a result, manufacturing costs and the size of the display apparatus may be reduced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a block diagram illustrating a display apparatus according to an exemplary embodiment of the present invention;

FIG. 2 is a plan view illustrating the first display part in FIG. 1;

FIG. 3 is a block diagram illustrating the integrated driver in FIG. 2;

FIG. 4 is a block diagram illustrating the second display part in FIG. 2;

FIG. 5A is a plan view illustrating the second display panel in FIG. 4;

FIG. 5B is an equivalent circuit diagram illustrating the second display panel in FIG. 4;

FIG. 6 is a block diagram illustrating the voltage adjusting part in FIG. 4; and

FIG. 7 is an equivalent circuit diagram illustrating the voltage transforming part in FIG. 6.

### DESCRIPTION OF THE EMBODIMENTS

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

Hereinafter, the present invention will be explained in detail with reference to the accompanying drawings.

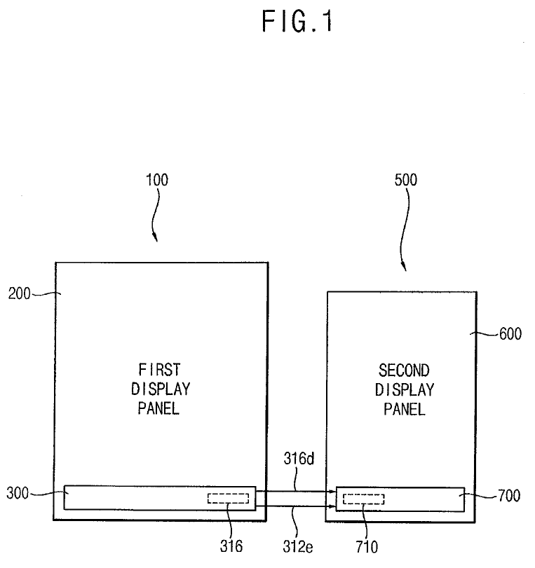

FIG. 1 is a block diagram illustrating a display apparatus according to an exemplary embodiment of the present invention.

Referring to FIG. 1, a display apparatus according to an exemplary embodiment of the present invention includes a first display part 100 and a second display part 500. The first display part 100 displays a main image, and the second display part 500 displays a sub-image. The first display part 100 corresponds to an active matrix type, and the second display part 500 corresponds to a passive matrix type.

The first display part 100 includes a first display panel 200 and a first driver circuit 300. The first display panel 200 displays the main image. The first driver circuit 300 drives the first display panel 200. The first driver circuit 300 includes a voltage generating part 316 generating a first driving voltage for driving the first display panel 200.

The second display part 500 includes a second display panel 600 and a second driver circuit 700. The second display panel 600 displays the sub-image. The second driver circuit 700 drives the second display panel 600. The second driver circuit 700 includes a voltage adjusting part 710. The voltage adjusting part 710 receives a basic driving voltage 316d from the voltage generating part 316 of the first display part 100 to generate a second driving voltage. The basic driving voltage 316d is one selected from the first driving voltages. The voltage adjusting part 710 also receives level control signals 312e for controlling a level of the second driving voltage from the first driver circuit 300.

Hereinafter, the first and second display parts 100 and 500 are explained in detail referring to figures.

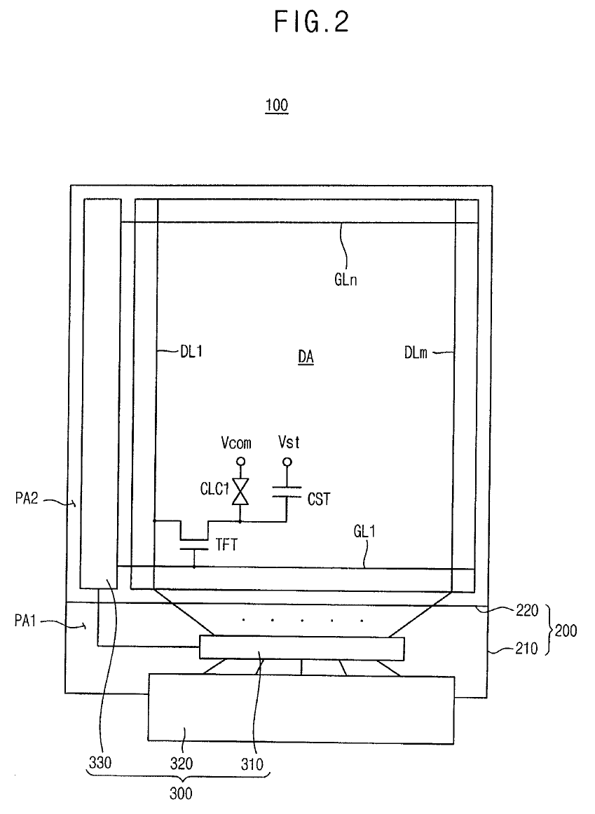

FIG. 2 is a plan view illustrating the first display part in FIG. 1. Referring to FIG. 2, the first display part 100 according to the present embodiment includes the first display panel 200, an integrated driver part 310, a flexible printed circuit board (FPCB) 320 and a gate driver part 330. The integrated driver part 310, the FPCB 320 and the gate driver part 330 are defined as the first driver circuit part 300.

The first display panel 200 includes an array substrate 210, an opposite substrate 220, and a liquid crystal layer (not shown). The array substrate 210 and the opposite substrate 220 are combined with each other, and the liquid crystal layer is disposed between the array substrate 210 and the opposite substrate 220. The first display panel 220 includes a display area DA, a first peripheral area PA1 and a second peripheral area PA2. An image is displayed through the display area DA. The first and second peripheral areas PA1 and PA2 surround the display area DA.

A plurality of gate lines GL1 to GLn are extended along a first direction in the display area DA, and a plurality of source lines DL1 to DLm are extended along a second direction crossing the first direction in the display area DA, wherein ‘m’ and ‘n’ are natural numbers. A plurality of first pixels is formed in the display area DA. Each of the first pixels includes a switching element TFT, a first liquid crystal capacitor CLC1, and a storage capacitor CST. A thin-film transistor (TFT) may be employed as the switching element TFT. The first liquid crystal capacitor CLC1 and the storage capacitor CST are electrically connected to the switching element TFT. The gate electrode of the switching element TFT is electrically connected to one of the gate lines GL1 to GLn. A source electrode of the switching element TFT is electrically connected to one of the source lines DL1 to DLm. A drain electrode of the switching element TFT is electrically connected to the first liquid crystal capacitor CLC1 and the storage capacitor CST. The first liquid crystal capacitor CLC1 includes a pixel electrode (not shown) electrically connected to the switching element TFT, a common electrode (not shown) and a liquid crystal layer (not shown) disposed between the pixel electrode and the common electrode. The liquid crystal layer corresponds to a dielectric layer of the first liquid crystal capacitor CLC1.

The first peripheral area PA1 is located in an end portion of the source lines DL1 to DLm. The second peripheral area PA2 is located in an end portion of the gate lines GL1 to GLn.

The integrated driver 310 may be formed as a chip mounted on the first peripheral area PA1. The integrated driver 310 applies a data signal (or a data voltage) of an analog type to the source lines DL1 to DLm, and outputs a gate control signal for controlling the gate driver 330.

A first end portion of the FPCB 320 is connected to the first peripheral area PA1, and a second end portion of the FPCB 320 is electrically connected to an external device so that the FPCB 320 electrically connects the integrated driver 310 to the external device. The FPCB 320 transfers a first image signal and a first synchronous signal for controlling an image from the external device to the integrated driver 310.

The gate driver 330 is formed in the second peripheral area PA2 as an integrated circuit. The gate driver part 330 receives the gate control signal from the integrated driver 310, and sequentially outputs gate signals to the gate lines GL1 to GLn in response to the gate control signal.

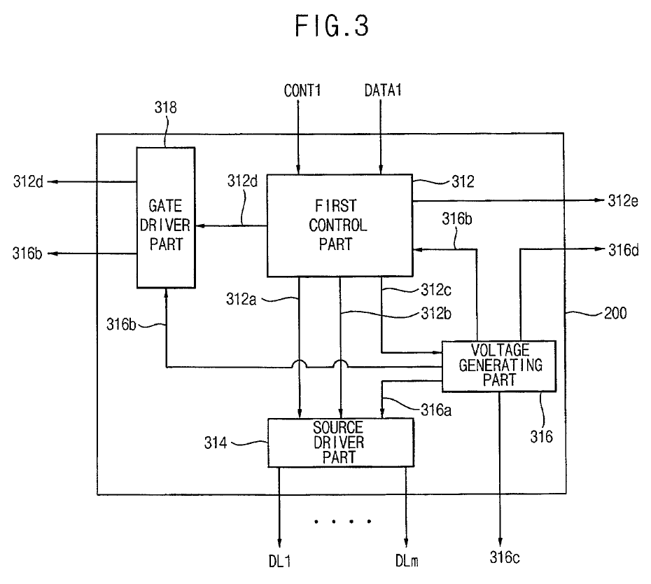

FIG. 3 is a block diagram illustrating the integrated driver in FIG. 2.

Referring to FIGS. 1 to 3, the integrated driver 310 includes a first control part 312, a source driver 314, a voltage generating part 316 and a gate control 318.

The first control part 312 receives a first image signal DATA1 and a first synchronous signal CONT1 for controlling an image displayed by the first data signal DATA1. The first synchronous signal CONT1 includes a vertical synchronous signal VSNC representing a time required for displaying one frame, a horizontal synchronous signal HSYNC representing a time required for displaying one horizontal line, a data enable signal DE representing a time required for providing the pixel with data, and a main clock signal MCLK corresponding to a reference for timing.

The first control part 312 transforms the first image signal DATA1 of an analog type into a first image data 312a of a digital type, which is applied to the first display panel 200, and provides the source driver 314 with the first image data 312a. The first control part 312 also generates control signals corresponding to the first image data 312a, based on the first synchronous signals CONT1 and provides each part with the control signals. The first control part 312 generates a source control signal 312b, a voltage control signal 312c and a gate control signal 312d, which correspond to the first image data 312a, and provides the source driver 314, the voltage generating part 316 and the gate control part 318 with the source control signal 312b, the voltage control signal 312c and the gate control signal 312d, respectively.

The source control signal 312b includes a horizontal start signal STH for representing a start of a horizontal line, a load signal TP instructing output of data corresponding to one horizontal line, and a data clock signal DCLK corresponding to a timing reference. The gate control signal 312d includes a first clock signal CK, a second clock signal CKB, and a vertical start signal STV. The first and second clock signals CK and CKB have opposite phases to each other. The first and second clock signals CK and CKB are generated by combining a gate-on signal Von and a gate-off signal Voff provided from the voltage generating part 316. The vertical start signal STV instructs outputs of a gate signal.

The first control part 312 generates the level control signals 312e for controlling a level of the second driving voltages to provide the voltage adjusting part 710 with the level control signals 312e.

The source driver 314 converts the first image data 312a of a digital type to the data signal (or data voltage) of an analog type, based on the source control signal 312b to apply the data signal to source lines DL1 to DLm. The data signals applied to the source lines DL1 to DLm are generated by using gamma reference voltages 316a provided from the voltage generating part 316.

The voltage generating part 316 generates the first driving voltages for driving the first display panel 200 from an external voltage. The first driving voltages include the gamma reference voltage 316a for driving the source driver 314, a gate driving voltage 316b for driving the gate driver 330, and a common voltage 316c applied to the common electrode (not shown) of the first liquid crystal capacitor CLC1. The gate driving voltage 316b includes the gate-on voltage Von corresponding to a high level of the gate signal, and the gate-off voltage Voff corresponding to a low level of the gate signal. The common voltage 316c includes a high-level common voltage VcomH that is higher than a reference voltage (for example, an average of the common voltage), and a low-level common voltage VcomL that is lower than the reference voltage.

The voltage generating part 316 provides the source driver 314 with the gamma reference voltages 316a. The voltage generating part 316 provides the first and second control parts 312 and 318 with the gate driving voltage 316b. The voltage generating part 316 provides the first display panel 200 with the common voltage 316c. The gate driving voltage 316b applied to the gate control part 318 includes only the gate-off voltage Voff.

The voltage generating part 316 provides the voltage adjusting part 710 of the second display part 500 with a portion of the first driving voltage as the basic driving voltages 316d. The basic driving voltages 316d include, for example, the high-level common voltage VcomH, the gate-on voltage Von and the gate-off voltage Voff.

The gate control part 318 provides the gate driver 330 with the gate control signal 312e and the gate driving voltage 316b. In detail, the gate control part 318 provides the gate driver 330 with the first clock signal CK, the second clock signal CKB, the vertical start signal STV, the gate-off voltage Voff to drive the gate driver 330.

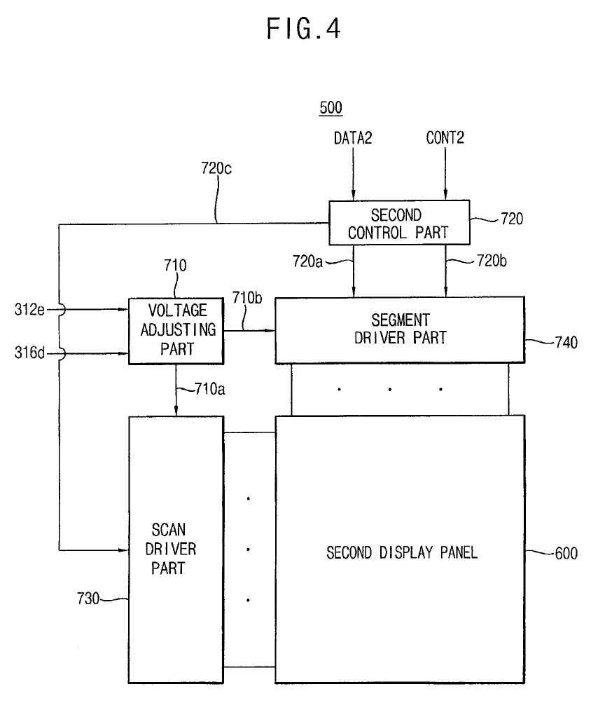

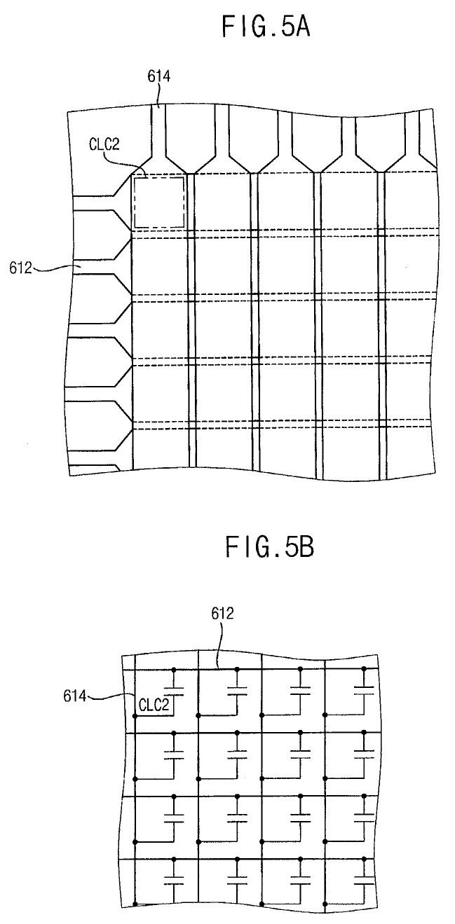

Hereinafter, the second display part 500 will be explained referring to FIGS. 4, 5A and 5B.

FIG. 4 is a block diagram illustrating the second display part in FIG. 2. FIG. 5A is a plan view illustrating the second display panel in FIG. 4, and FIG. 5B is an equivalent circuit diagram illustrating the second display panel in FIG. 4.

Referring to FIGS. 3 and 4, the second display part 500 according to the present embodiment includes a second display panel 600, a voltage adjusting part 710, a second control part 720, a scan driver part 730 and a segment driver part 740. The voltage adjusting part 710, the second control part 720, the scan driver 730, and the segment driver 740 define a second driver circuit 700 driving the second display panel 600. The voltage adjusting part 710, the second control part 720, the scan driver 730, and the segment driver 740 may be integrated into one chip.

The second display panel 600 includes a first substrate (not shown), a second substrate (not shown) facing the first substrate, and a liquid crystal layer (not shown) disposed between the first and second substrates. The second display panel 600 will be explained in detail, referring to FIGS. 5A and 5B.

The second display panel 600 includes a plurality of scan electrodes 612 and a plurality of segment electrodes 614 extended along a direction crossing a longitudinal direction of the scan electrodes 612. The regions, where the scan electrodes 612 and the segment electrodes 614 overlap with each other, correspond to second pixels. The scan electrodes 612, the segment electrodes 614, and the liquid crystal layer disposed between the scan electrodes 612 define second liquid crystal capacitors CLC2. The scan electrodes 612 and the segment electrodes 614 correspond to two electrodes of the second liquid crystal capacitors CLC2, and the liquid crystal layer corresponds to a dielectric layer of the second liquid crystal capacitors CLC2. The second liquid crystal capacitors CLC2 correspond to the second pixels.

The voltage adjusting part 710 receives the basic driving voltages 316d from the voltage generating part 316 to generate the second driving voltage for driving the second display panel 600 according to the level control signals 312e from the first control part 312. In other words, the voltage adjusting part 710 adjusts first driving voltages to generate the second driving voltages for driving the second display panel 600 in accordance with the level control signals 312e.

The second driving voltages includes a scan driving voltage 710a for driving the scan driver part 730, and a segment driving voltage 710b for driving the segment driver 740. The scan driving voltage 710a includes a mid-level scan voltage VCM that corresponds to a reference voltage, a high-level scan voltage VCH that is higher than the mid-level scan voltage VCM, and a low-level scan voltage VCL that is lower than the mid-level scan voltage VCM. The segment driving voltage 710b includes a high-level segment voltage VSH that is higher than the mid-level scan voltage VCM, and a low-level segment voltage VSL that is lower than the mid-level scan voltage VCM. The voltage difference between the high-level scan voltage VCH and the mid-level scan voltage VCM is substantially the same as a voltage difference between the mid-level scan voltage VCM and the lower level scan voltage VCL. Further more, the voltage difference between the high-level segment voltage VSH and the mid-level scan voltage VCM is substantially the same as the voltage difference between the mid-level scan voltage VCM and the lower level segment voltage VSL.

For example, the voltage adjusting part 710 receives the high-level common voltage VcomH, the gate-on voltage Von and the gate-off voltage Voff from the voltage generating part 316. The voltage adjusting part 710 adjusts the high-level common voltage VcomH to generate the high-level segment voltage VSH. The voltage adjusting part 710 also adjusts the gate-on voltage Von and the gate-off voltage Voff to respectively generate the high-level scan voltage VCH and the low-level scan voltage VCL. The low-level segment voltage may correspond to a ground voltage GND. The high-level segment voltage VSH and the low-level segment voltage VSL may be bisected to generate the mid-level scan voltage VCM.

The level control signals 312e are pulse width modulation (PWM) signals. A level of the second driving voltages may be adjusted in accordance with a duty ratio of “on” to “off” of the PWM signals.

The second control part 720 receives the second image signal DATA2 and the second synchronous signal CONT2 for controlling the display of the second image signal DATA2. The second control part 720 adjusts the second image signal DATA2 to be applied to the second display panel to generate the second image data 720a applied to the segment driver 740. Furthermore, the second control part 720 generates the segment control signal 720b and the scan control signal 720c to provide the segment driver 740 and the scan driver 730 with the segment control signal 720b and the scan control signal 720c, respectively. The second control signal 720b includes a latch clock for making a record of the second image data 720a, a horizontal start signal representing one horizontal period, and an inversion signal for polarity-inversion driving. The scan control signal 720c includes a vertical start signal representing a period of one frame, a horizontal start signal representing one horizontal period, an the inversion signal.

The second control part 720 may receive the second image signal DATA2 and the second synchronous signals CONT2 from the first control part 312 of the integrated driver 310. Alternatively, the second control part 710 may receive the second image signal DATA2 and the second synchronous signals CONT2 from an external device as well as the first integrated driver 310.

The scan driver 730 applies scan output voltages to the scan electrodes 612, based on the scan driving voltages 710b in response to the scan control signal 720c. The scan output voltages correspond to the high-level scan voltage VCH or the low-level scan voltage VCL when the scan electrode 612 is selected in response to the inversion signal in the scan control signal 720c, and the scan output voltages correspond to the mid-level scan voltage VCM when the scan electrode 612 is not selected. As a result, the high-level scan voltage VCH or the low-level scan voltage VCL corresponds to a selection voltage activating the scan electrode 612, and the mid-level scan voltage VCM corresponds to a non-selection voltage.

The segment driver 740 applies segment output voltages based on segment driving voltages to the segment electrodes 614 in response to the second image data 720a and the segment control signal 720b. The segment output voltages correspond to the high-level segment voltage VSH or the low-level segment voltage VSL in accordance with the second image data 720a and the inversion signal in the segment control signal 720b.

The scan driver 730 and the segment driver 740 operate, and a voltage difference is generated between the scan electrode 612 and the segment electrode 614 of the second liquid crystal capacitor CLC2 in the second pixel, so that the second pixel is determined to be in a display state or a non-display state according to an effective value of the voltage difference during a frame.

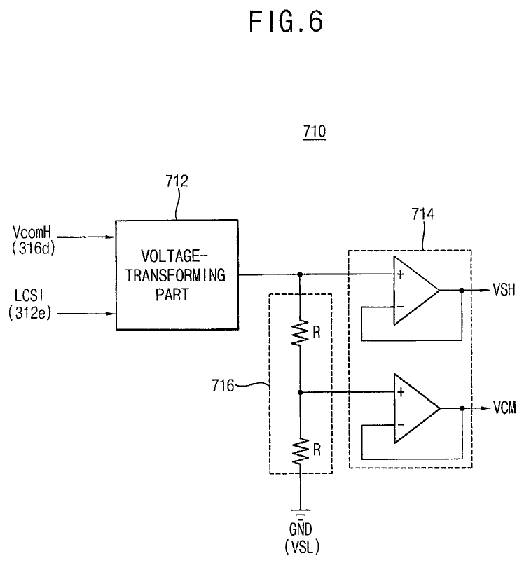

Hereinafter, the voltage adjusting part 710 will be explained in detail referring to FIG. 6.

FIG. 6 is a block diagram illustrating the voltage adjusting part in FIG. 4.

For convenience, a structure for generating the high-level segment voltage VSH will be explained. Referring to FIGS. 3 to 6, the voltage adjusting part 710 includes a voltage transforming part 712 and a buffer part 714.

The voltage transforming part 712 transforms the basic driving voltages 316d (or the first driving voltage) received from the voltage generating part 316 to the second driving voltage having a different voltage level from that of the basic driving voltages 316d according to the level control signals 312e. For example, the voltage transforming part 712 transforms the high-level common voltage VcomH to the high-level segment voltage VSH by changing the voltage level in accordance with the first level control signal LCS1. The first level control signal LCS1 corresponds to a control signal for controlling a level of the high-level segment voltage VSH. The voltage transforming part 712 adjusts the level of the high-level segment voltage VSH in accordance with a duty ratio of “on” to “off” of the first level control signal LCS1.

The buffer part 714 stabilizes the second driving voltage outputted from the voltage transforming part 712. In detail, the buffer 714 stabilizes the high-level segment voltage VSH outputted from the voltage transforming part 712 to output the stabilized high-level segment voltage VSH. The stabilized high-level segment voltage VSH and the low-level segment voltage VSL corresponding to the ground voltage GND are applied to the segment driver 740.

The voltage adjusting part 710 may further include a voltage dividing part 716 for generating the mid-level scan voltage VCM.

The voltage dividing part 716 includes two resistors R connected in series between an output terminal of the voltage transforming part 712 and the ground voltage GND. The voltage dividing part 716 bisects the voltage difference between the high-level segment voltage VSH outputted from the voltage transforming part 712 and the ground voltage GND (for example, the low-level segment voltage VSL) to generate the mid-level scan voltage VCM. The mid-level scan voltage VCM outputted from the voltage transforming part 716 is stabilized through the buffer part 714 to be outputted. For example, the mid-level scan voltage VCM is generated through the voltage dividing part 716. Alternatively, the mid-level scan voltage VCM may be generated through the voltage transforming part 712 likewise the high-level segment voltage VSH.

Not shown in FIG. 6, the voltage transforming part 712 transforms the gate-on voltage Von according to the second level control signal to generate the high-level scan voltage VCH, and transforms the gate-off voltage Voff according to the third level control signal to generate the low-level scan voltage VCL. The high-level scan voltage VCH and the low-level scan voltage VCL generated by the voltage transforming part 712 are stabilized by the buffer 714 to be outputted. Preferably, the voltage transforming part 712 and the buffer 714 for generating the high-level scan voltage VCH and the low-level scan voltage VCL may be separately formed with a structure for forming the high-level segment voltage VSH.

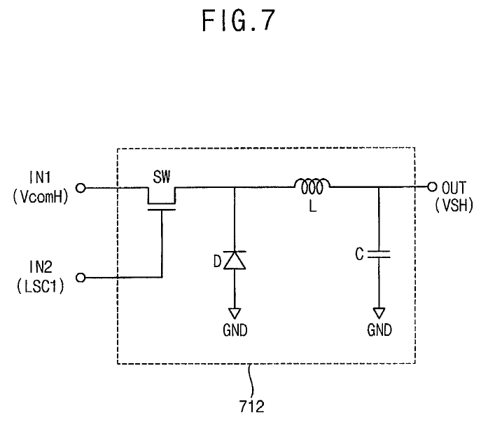

FIG. 7 is an equivalent circuit diagram illustrating the voltage transforming part in FIG. 6.

Referring to FIGS. 6 and 7, the voltage transforming part 712 corresponds to a buck converter that is a step-down converter. The voltage transforming part 712 includes a switching element SW, an inductor L, a capacitor C and a diode D.

In detail, the switching element SW includes a first electrode, a second electrode (or a control electrode) and a third electrode. The first electrode of the switching element SW is electrically connected to a first node IN1 to which the high-level common voltage VcomH is applied. The second electrode of the switching element SW is electrically connected to a second node IN2 to which the first level control signal LCS1 is applied. The inductor L includes an input terminal and an output terminal. The input terminal of the inductor L is electrically connected to the third electrode of the switching element SW. The output terminal of the inductor L is electrically connected to an output node OUT. The capacitor is disposed between the output terminal of the inductor L and the ground GND. The diode D includes an anode and a cathode. The anode is electrically connected to the ground GND, and the cathode is electrically connected to the input terminal of the inductor L. A voltage of the output node OUT corresponds to the high-level segment voltage VSH.

Hereinafter, the operation of the voltage transforming part 712 will be explained.

When the first level control signal LCS1 is high, the switching element SW is turned on, so that the high-level common voltage VcomH is applied to the inductor L through the switching element SW. As a result, a current flowing through the inductor L gradually increases to electrically charge the capacitor C and flows toward the output node OUT to raise the voltage level of the output terminal OUT. In other words, when the switching element is turned on, the inductor L and the capacitor C are electromagnetically charged and the voltage level of the output terminal OUT is raised. The diode D transmits no current since the diode D is reversely biased due to the high-level common voltage VcomH.

When the first level control signal LCS1 is low, the switching element SW is turned off, so that the high-level common voltage VcomH is not applied to the inductor L. However, the inductor L maintains the current for a short time, so that the current flows through the output node OUT and the diode D. As the inductor L is electromagnetically discharged, the current flowing through the inductor L decrease to lower the level of the output node OUT. Furthermore, charges stored in the capacitor C flow out through the output node OUT, so that the capacitor is discharged. In other words, when the switching device SW is turned off, the inductor L and the capacitor C are discharged and the voltage level of the output node OUT is gradually lowered.

As described above, as the switching element SW is alternately turned on and off due to the first level control signal LCS1, the level of the output node OUT is alternately raised and lowered. An average value of the output node OUT corresponds to a level of the high-level segment voltage VSH. Therefore, the level of the high-level segment voltage VSH is adjusted according to the duty ratio (or a ratio of “on” to “off”) of the switching element SW. As the ratio of “on” to “off” of the switching element SW increases, the level of the high-level segment voltage VSH also increases. In short, the level of the high-level segment voltage VSH is controlled by the duty ratio of the first level control signal LCS1.

The voltage transforming part 712 employs, for example, a buck converter that is a step-down converter. Alternatively, when the second driving voltage is higher than the first driving voltage, the voltage transforming part 712 may employ a boost converter that is a step-up converter.

As described above, according to the present invention, the voltage adjusting part 710 receives a portion of the first driving voltages generated from the voltage generating part 316 to generate the second driving voltage according to the level control signals 312e provided by the first control part 312. Therefore, the second display part 500 does not require a driving voltage generating part for generating driving voltage. In order to precisely control the second driving voltages, the level control signals 312e are required. However, when the levels of the first driving voltages correspond to that of the second driving voltages, the level control signals 312e may be optional.

As described above, according to the present invention, a second display panel receives and uses a driving voltage generated by a voltage generating part of a first display panel. Therefore, the circuit for generating the driving voltage for driving the second display panel may be omitted. As a result, manufacturing costs may be reduced, and the area of a circuit may be reduced, so that the size of the display apparatus may be reduced. Having described the exemplary embodiments of the present invention and its advantages, it is noted that various changes, substitutions and alterations can be made herein without departing from the spirit and scope of the invention as defined by appended claims.

What is claimed is:

1. A display apparatus comprising:
a first display panel comprising a plurality of first pixels, each of which comprises a switching element electrically connected to a gate line and a source line, and a first liquid crystal capacitor electrically connected to the switching element;
a second display panel comprising a plurality of second pixels, each of which comprises a second liquid crystal capacitor formed by a scan electrode and a segment electrode extended along a direction crossing a longitudinal direction of the scan electrode;
a first driver circuit driving the first display panel by using first driving voltages; and
a second driver circuit driving the second display panel by using second driving voltages generated by adjusting the first driving voltages.

2. The display apparatus of claim 1, wherein the first driver circuit comprises:
a voltage generating part generating the first driving voltages; and
a first control part generating level control signals for controlling levels of the second driving voltages.

3. The display apparatus of claim 2, wherein the second driver circuit part comprises a voltage adjusting part adjusting the levels of the second driving voltages in accordance with the level control signals.

4. The display apparatus of claim 3, wherein the level control signals correspond to a pulse width modulation signal, and the levels of the second driving voltages are adjusted in accordance with a duty ratio of the level control signals.

5. The display apparatus of claim 3, wherein the voltage adjusting part comprises:
a voltage transforming part transforming the first driving voltages to generate the second driving voltages in accordance with the level control signals; and
a buffer stabilizing the second driving voltage outputted from the voltage transforming part.

6. The display apparatus of claim 5, wherein the first driver circuit comprises:
a gate driver applying a gate signal to the gate line under a control of the first control part; and
a source driver applying a source signal to the source line under a control of the first control.

7. The display apparatus of claim 6, wherein the second driver circuit comprises:
a segment driver applying a segment voltage to the segment electrode;
a scan driver applying a scan voltage to the scan electrode; and
a second control part controlling the segment driver and the scan driver.

8. The display apparatus of claim 7, wherein the first driving voltages comprises:
a gate driving voltage applied to the gate driver; and
a common voltage applied to the first liquid crystal capacitor.

9. The display apparatus of claim 8, wherein the gate driving voltage comprises a gate-on voltage corresponding to a high level of the gate signal, and a gate-off voltage corresponding to a low level of the gate signal, and
the common voltage comprises a high-level common voltage that is higher than a reference voltage, and a low-level common voltage that is lower than the reference voltage.

10. The display apparatus of claim 9, wherein the second driving voltage comprises a scan driving voltage applied to the scan driver, and a segment driving voltage applied to the segment driver.

11. The display apparatus of claim 10, wherein the scan driving voltage comprises a mid-level scan voltage, a high-level scan voltage higher than the mid-level scan voltage, and a low-level scan voltage lower than the mid-level scan voltage, and
the segment driving voltage comprises a high-level segment voltage higher than the mid-level scan voltage, and a low-level segment voltage lower than the mid-level scan voltage.

12. The display apparatus of claim 11, wherein the high-level segment voltage and the mid-level scan voltage are generated based on the high-level common voltage, the high-level scan voltage is generated based on the gate-on voltage, and the low-level scan voltage is generated based on the gate-off voltage.

13. The display apparatus of claim 12, wherein the voltage adjusting part bisects a voltage difference between the high-level segment driving voltage and a ground voltage to generate the mid-level scan voltage outputted to the buffer.

14. The display apparatus of claim 12, wherein the low-level segment voltage corresponds to a ground voltage.

15. The display apparatus of claim 6, wherein the first control part, the source driver, the voltage generating part are integrally formed to be a chip.

16. The display apparatus of claim 7, wherein the segment driver, the scan driver, the second control part and the voltage adjusting part are integrally formed to be a chip.

17. A method of driving a display apparatus, comprising:
generating a first driving voltage by using an external voltage source;
driving a first display panel by using the first driving voltage, the first display panel comprising a plurality of first pixels, each of which comprises a switching element and a first liquid crystal capacitor electrically connected to the switching element;
generating a second driving voltage by adjusting the first driving voltage; and
driving a second display panel by using the second driving voltage, the second display panel comprising a plurality of second pixels, each of which comprises a second liquid crystal capacitor formed by a scan electrode and a segment electrode extended along a direction crossing a longitudinal direction of the scan electrode.

18. The method of claim 17, wherein a level of the second driving voltage is controlled by a level control signal.

19. The method of claim 18, wherein the level control signal is a pulse width modulation (PWM) signal, and the level of the second driving voltage is controlled by a duty ratio of the level control signals.

20. The method of claim 17, further comprising stabilizing the second driving voltage.
